(19) United States
(12) Patent Application Publication
(10) Pub. No.: US 2011/0080432 A1
(43) Pub. Date: Apr. 7, 2011

(54) LIGHT EMITTING ELEMENT DRIVE CIRCUIT

(75) Inventors: Ken Nakazawa, Osaka (JP); Manabu Yamamoto, Osaka (JP)

(73) Assignee: Sharp Kabushiki Kaisha

(21) Appl. No.: 12/737,162

(22) PCT Filed: Mar. 9, 2009
(86) PCT No.: PCT/JP2009/054382

§ 371 Date: Dec. 14, 2010

(30) Foreign Application Priority Data
Jul. 15, 2008 (JP) 2008-183464

(51) Int. Cl. G09G 5/10; H05B 37/02

(52) U.S. Cl. 345/690; 315/186

(57) ABSTRACT

A plurality of LEDs are connected in series, and an FET that functions as a constant current source is provided for one end of the serially connected LEDs. Switches are connected in parallel with the LEDs. A switch control circuit controls on and off of the switches independently using switch control signals Xa to Xe, and changes all of the switches from an OFF state to an ON state at the same timing. A drive control circuit may control a gate voltage of the FET to be at low level according to the timing at which the switches change to the ON state. With this, it is possible to adjust luminance of the light emitting devices (LEDs) independently, and to prevent an overcurrent from flowing through the light emitting devices.

### TECHNICAL FIELD

The present invention relates to light emitting device drive circuits, and, in particular, to a light emitting device drive circuit that drives a plurality of light emitting devices that are connected in series with constant current.

### BACKGROUND ART

As a backlight for a liquid crystal display device, an LED backlight in which a plurality of LEDs (Light Emitting Diodes) are arranged two-dimensionally is often used. In order to maintain luminance of a backlight constant, the LED backlight employs a method of driving LEDs with constant current in which a plurality of LEDs are connected in series and a constant current source is provided for one end of the plurality of LEDs. However, as there is variation in characteristics of the LEDs, there is also variation in luminance of the LEDs even when the constant-current drive is performed. Therefore, in order to suppress the variation in the luminance of the LEDs, there is contrived an LED drive circuit having a function of adjusting the luminance of the LEDs independently (e.g., Patent Document 1).

FIG. 9 is a block diagram illustrating a structure of a conventional LED drive circuit. The LED drive circuit shown in FIG. 9 drives five LEDs 91 that are connected in series with constant current. Switches 92 are connected respectively in parallel with the LEDs 91, and each bypasses, when turned on, a current that flows through the corresponding LED 91. Each LED 91 is turned on when the corresponding switch 92 is in an OFF state, and turned off when the switch is in an ON state.

A drive control circuit 94 controls a gate voltage of an FET (Field Effect Transistor) 93 that functions as a constant current source. A switch control circuit 95 controls on and off of the switches 92 independently. A length of an OFF period of each switch 92 is determined based on the characteristics of the corresponding LED 91. According to the LED drive circuit thus configured, the luminance of each LED 91 is adjusted using the switch control circuit 95 independently, and it is possible to uniformize the luminance of the LEDs 91 even when there is variation in the characteristics of the LEDs 91.

[Patent Document 1] Japanese Laid-Open Patent Publication No. 2005-310996

### DISCLOSURE OF THE INVENTION

### Problems To Be Solved By The Invention

However, as described below, the LED drive circuit described above poses a problem that an overcurrent flows through the LEDs 91 that are being turned on when any of the LEDs 91 is turned off. An anode-cathode voltage of the LEDs that are being turned on is represented by Vf (where Vf is a positive value). When the corresponding one of the switches 92 is changed from the OFF state to the ON state in order to turn off any of the LEDs 91, the anode-cathode voltage of the LED becomes Vz that is sufficiently lower than Vf. The voltage Vz at this time substantially equals to 0. In the following, it is assumed that Vz=0 in order to simplify the description.

As the circuit in which the LEDs 91 and the FET 93 are connected in series is applied with a constant power supply voltage, a drain voltage of the FET 93 (the voltage at a node P) increases by an amount (k×Vf) when k switches of the five switches 92 are turned to the ON state (that is, the k LEDs 91 are turned off). As a parasitic capacitance 96 is present between a drain and a gate of the FET 93, a gate voltage (the voltage at a node Q) increases when the drain voltage increases. The voltage at the node Q returns to an original level within a short period of time due to an action of the drive control circuit 94 that causes the FET 93 to function as the constant current source. However, in the short period of time during which the voltage of the node Q is higher than setting, an amount of current that is greater than that has been set flows through the LEDs 91 that are being turned on, and the LEDs 91 emit light at higher luminance than that has been set. Further, as an excessive current stress is applied to the LEDs 91 that are being turned on, life duration of the LEDs 91 decreases.

Thus, an object of the present invention is to provide a display device capable of adjusting luminance of light emitting devices independently, and preventing an overcurrent from flowing through the light emitting devices.

### Means For Solving the Problems

According to a first aspect of the present invention, there is provided a light emitting device drive circuit that drives a plurality of light emitting devices that are connected in series with constant current, the circuit including: a constant current source that is connected in series to the light emitting devices; a plurality of switches that are respectively connected in parallel with the light emitting devices; and a switch control circuit that controls on and off of the switches independently and changes all of the switches from an OFF state to an ON state at a same timing.

According to a second aspect of the present invention, in the first aspect of the present invention, the light emitting device drive circuit further includes a drive control circuit that stops an operation of the constant current source according to the timing at which the switches change to the ON state.

According to a third aspect of the present invention, in the second aspect of the present invention, the drive control circuit stops the operation of the constant current source before the switches change to the ON state.

According to a fourth aspect of the present invention, there is provided a display device, including: a backlight drive circuit configured as the light emitting device drive circuit according to one of the first to third aspect of the present invention.

### Effects of the Invention

According to the first aspect of the present invention, all of the switches change from the OFF state to the ON state at the same timing. Consequently, even if a current that flows through the constant current source temporarily increases when the switches change to the ON state, this current does not flow through the light emitting devices. Therefore, it is possible to adjust luminance of the light emitting devices independently, and to prevent an overcurrent from flowing through the light emitting devices. Further, it is possible to reduce a current stress to the light emitting devices, and to extend life duration of the light emitting devices.

According to the second aspect of the present invention, it is possible to effectively prevent an overcurrent from flowing through the light emitting devices by stopping an operation of the constant current source according to the timing at which the switches change to the ON state.

According to the third aspect of the present invention, by stopping the operation of the constant current source before the switches change to the ON state, it is possible to prevent an overcurrent from flowing through the light emitting devices even when there is variation in the timing at which the switches change to the ON state.

According to the fourth aspect of the present invention, it is possible to prevent an overcurrent from flowing through the light emitting devices that constitute a backlight, and to extend life duration of the backlight.

### BRIEF DESCRIPTION OF THE DRAWINGS

FIG. 1 is a block diagram illustrating a structure of an LED drive circuit according to a first embodiment of the present invention.

FIG. 2 is a block diagram illustrating a structure of a liquid crystal display device provided with the LED drive circuit illustrated in FIG. 1.

FIG. 3A is a diagram illustrating a path of a drive current (first example) in the LED drive circuit illustrated in FIG. 1.

FIG. 3B is a diagram illustrating a path of the drive current (second example) in the LED drive circuit illustrated in FIG. 1.

FIG. 3C is a diagram illustrating a path of the drive current (third example) in the LED drive circuit illustrated in FIG. 1.

FIG. 4 is a timing chart of the LED drive circuit illustrated in FIG. 1.

FIG. 5 is a timing chart of a conventional LED drive circuit.

FIG. 6 is a block diagram illustrating a structure of an LED drive circuit according to a second embodiment of the present invention.

FIG. 7 is a timing chart of the LED drive circuit illustrated in FIG. 6.

FIG. 8 is another timing chart of the LED drive circuit illustrated in FIG. 6.

FIG. 9 is a block diagram illustrating a structure of the conventional LED drive circuit.

### DESCRIPTION OF THE REFERENCE NUMERALS

1: LIQUID CRYSTAL PANEL

2: DISPLAY CONTROL CIRCUIT

3: SCANNING SIGNAL LINE DRIVE CIRCUIT

4: DATA SIGNAL LINE DRIVE CIRCUIT

5: LED BACKLIGHT

6: BACKLIGHT DRIVE CIRCUIT

7: PIXEL

10, 20: LED DRIVE CIRCUIT

11: LED

12: SWITCH

13: FET

14, 24: DRIVE CONTROL CIRCUIT

15, 25: SWITCH CONTROL CIRCUIT

### BEST MODE FOR CARRYING OUT THE INVENTION

### First Embodiment

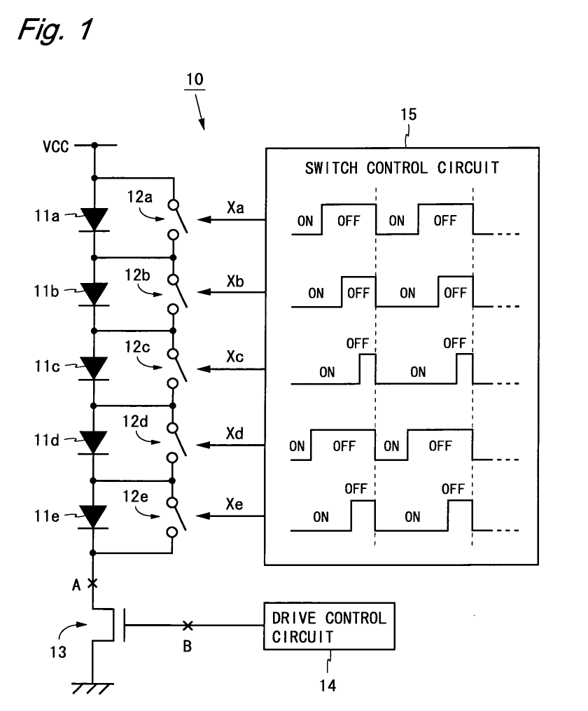

FIG. 1 is a block diagram illustrating a structure of an LED drive circuit according to a first embodiment of the present invention. An LED drive circuit 10 shown in FIG. 1 is provided with switches 12a to 12e, an FET 13, a drive control circuit 14, and a switch control circuit 15, and the LED drive circuit 10 drives LEDs 11a to 11e with constant current. Here, the LED drive circuit 10 drives five LEDs, but a number of the LEDs driven by the LED drive circuit 10 can be any number that is two or greater. In other words, the LED drive circuit 10 that drives two or more LEDs provides an effect described later.

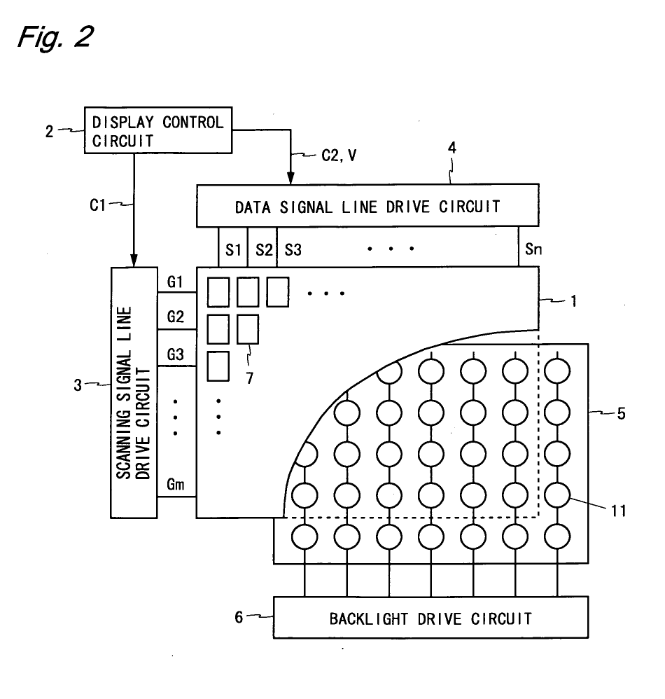

Before describing the LED drive circuit 10 in detail, one example of an aspect of an application of the LED drive circuit 10 is described with reference to FIG. 2. FIG. 2 is a block diagram illustrating a structure of a liquid crystal display device provided with the LED drive circuit 10. The liquid crystal display device illustrated in FIG. 2 is provided with a liquid crystal panel 1, a display control circuit 2, a scanning signal line drive circuit 3, a data signal line drive circuit 4, an LED backlight 5, and a backlight drive circuit 6.

The liquid crystal panel 1 includes m scanning signal lines G1 to Gm, n data signal lines S1 to Sn, and (m×n) pixels 7. The display control circuit 2 outputs a timing control signal C1 to the scanning signal line drive circuit 3 and a timing control signal C2 and a video signal V to the data signal line drive circuit 4. The scanning signal line drive circuit 3 selects the scanning signal lines G1 to Gm sequentially based on the timing control signal C1. The data signal line drive circuit 4 applies voltages according to the video signal V to the data signal lines S1 to Sn based on the timing control signal C2. With this, the voltages applied to the data signal lines S1 to Sn are written to the pixels 7 connected to the selected scanning signal lines. Luminance of the pixel 7 varies according to the voltage written thereto.

The LED backlight 5 is provided on a back side of the liquid crystal panel 1, and irradiates a back surface of the liquid crystal panel 1 with light. The LED backlight 5 includes the plurality of LEDs 11 that are arranged two-dimensionally. The LEDs 11 are divided into a plurality of groups, and the LEDs 11 of the same group are connected in series. The backlight drive circuit 6 drives the LEDs 11 by a group.

Among the components of the LED drive circuit 10 illustrated in FIG. 1, the switches 12a to 12e are arranged within the LED backlight 5 along with the LEDs 11a to 11e, and the FET 13, the drive control circuit 14, and the switch control circuit 15 are provided within the backlight drive circuit 6. Further, while the LEDs 11 are divided into groups by row in FIG. 2, the LEDs 11 can be divided into groups by any method.

Referring back to FIG. 1, the LED drive circuit 10 is described in detail in the following. As shown in FIG. 1, the five LEDs 11a to 11e driven by the LED drive circuit 10 are connected in series. A power supply voltage Vcc is applied to one end of the LEDs 11a to 11e connected in series, and the other end is grounded via the FET 13. The FET 13 is an N-channel transistor, and a gate terminal of the FET 13 is connected to an output terminal of the drive control circuit 14. The drive control circuit 14 controls a gate voltage of the FET 13 such that an amount of a current that flows through the FET 13 (hereinafter referred to as the drive current) corresponds to a predetermined target value. With this, the FET 13 functions as a constant current source.

The switches 12a to 12e are connected in parallel with the LEDs 11a to 11e, respectively. The switch control circuit 15 controls on and off of the switches 12a to 12e independently using switch control signals Xa to Xe. In the following, the switches 12a to 12e are in an OFF state respectively when the switch control signals Xa to Xe are at high level, and are in an ON state respectively when the switch control signals Xa to Xe are at low level.

In a time period during which the switch control signal Xa is at high level, the switch 12a is in the OFF state. At this time, the LED 11a is turned on as the drive current flows through the LED 11a. In contrast, in a time period during which the switch control signal Xa is at low level, the switch 12a is in the ON state. At this time, the LED 11a is turned off as drive current does not flow through the LED 11a. In this manner, the switch 12a bypasses, when turned on, the current that flows through the LED 11a. This also applies to the LEDs 11b to 11e and the switches 12b to 12e.

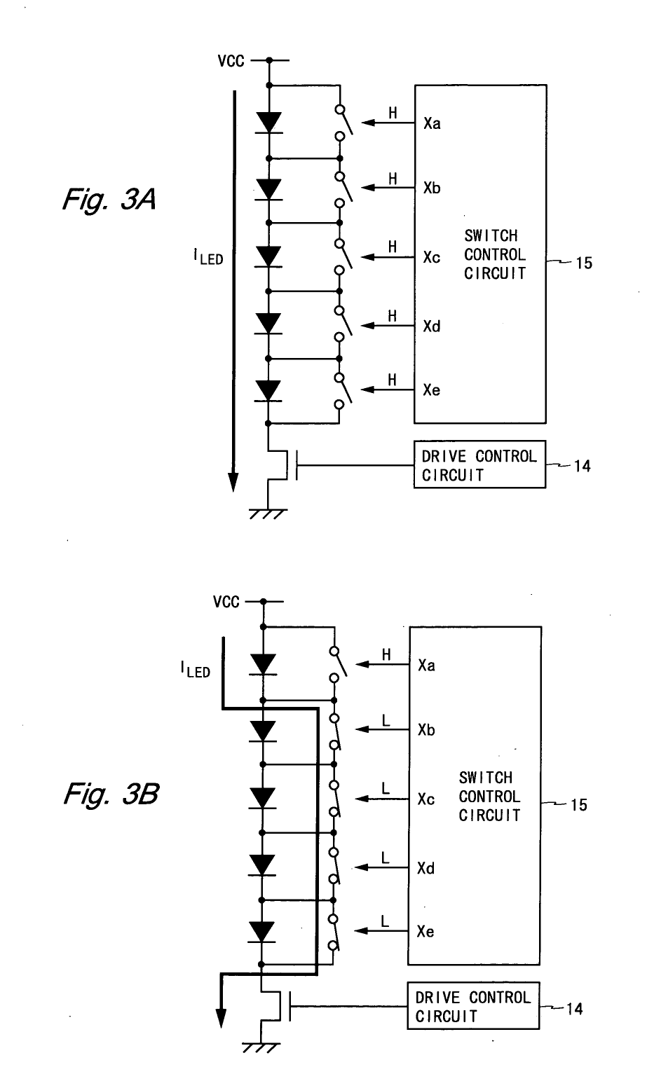

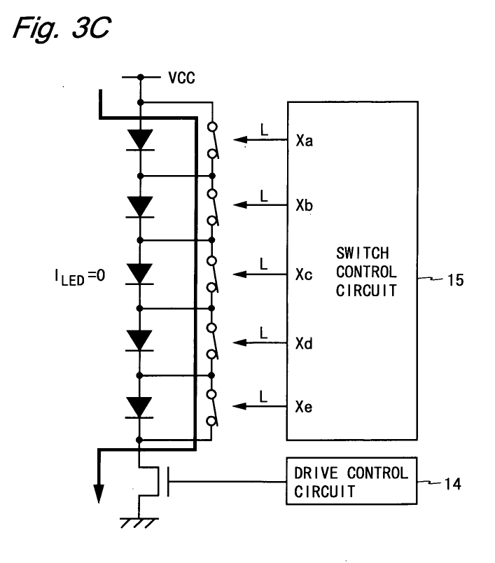

FIG. 3A to FIG. 3C are diagrams each illustrating an example of a path of the drive current in the LED drive circuit 10. When all of the switch control signals Xa to Xe are at high level (FIG. 3A), all of the switches 12a to 12e are in the OFF state, and the drive current flows through the LEDs 11a to 11e. Accordingly, all of the LEDs 11a to 11e are turned on. When the switch control signal Xa is at high level and the switch control signals Xb to Xe are at low level (FIG. 3B), the switch 12a is in the OFF state and the switches 12b to 12e are in the ON state, and the drive current flows through the LED 11a but not through the LEDs 11b to 11e. Accordingly, the LED 11a is turned on and the LEDs 11b to 11e are turned off. When all of the switch control signals Xa to Xe are at low level (FIG. 3C), all of the switches 12a to 12e are in the ON state, and the drive current does not flow through the LEDs 11a to 11e. Accordingly, all of the LEDs 11a to 11e are turned off.

In the LED drive circuit 10, a length of the time period during which each of the switch control signals Xa to Xe is at high level (equals to a time period during which each of the LEDs 11a to 11e is turned on) is determined depending on characteristics of the LEDs 11a to 11e. Therefore, according to the LED drive circuit 10, it is possible to uniformize the luminance of the LEDs 11a to 11e even when there is variation in the characteristics of the LEDs 11a to 11e by adjusting the luminance of the LEDs 11a to 11e independently using the switch control circuit 15.

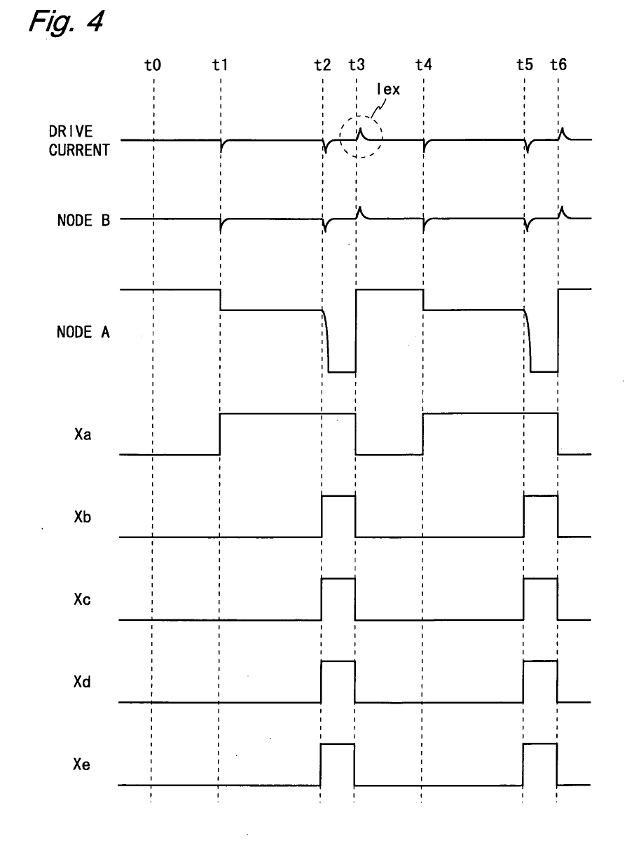

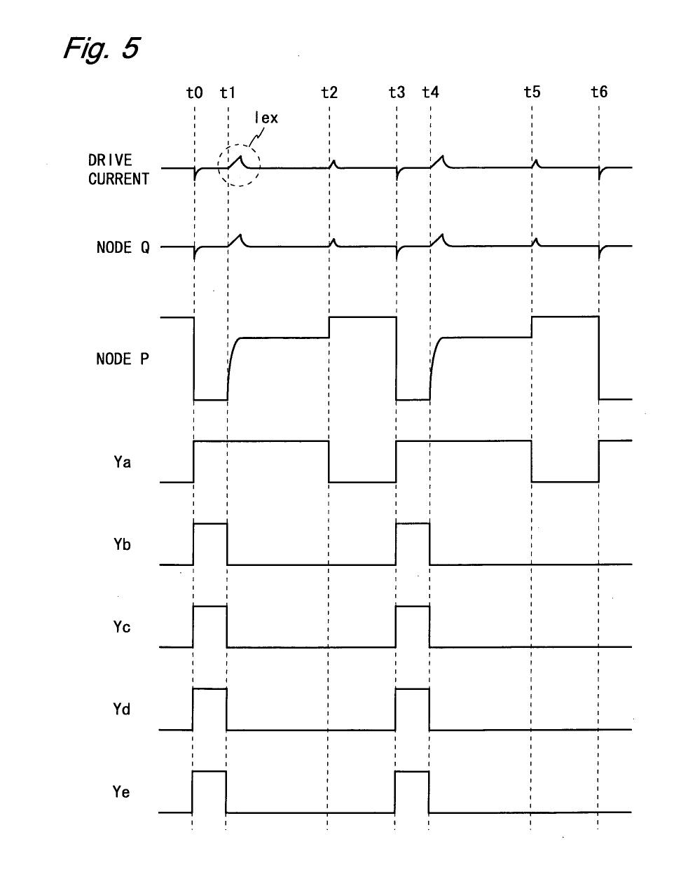

In addition, the switch control circuit 15 is characterized in that it is possible to change all of the switches 12a to 12e from the OFF state to the ON state at the same timing by switching the switch control signals Xa to Xe from high level to low level at the same timing. The following describes an effect of the LED drive circuit 10 provided with the switch control circuit 15 having the above characteristics with reference to FIG. 4 and FIG. 5. In the description below, an anode-cathode voltage of the LED that is being turned on is Vf, and an anode-cathode voltage of the LED that is being turned off is 0.

FIG. 4 is a timing chart of the LED drive circuit 10. All of the switch control signals Xa to Xe are at low level at a time t0. Then, the switch control signal Xa changes to high level at a time t1, and the switch control signals Xb to Xe change to high level at a time t2. Further, the switch control signals Xa to Xe change to low level at a time t3. Therefore, all of the switches 12a to 12e change from the ON state to the OFF state at the same timing. The LED drive circuit 10 is in a state shown in FIG. 3B from the time t1 to the time t2, in a state shown in FIG. 3A from the time t2 to the time t3, and in a state shown in FIG. 3C from the time t3 to a time t4.

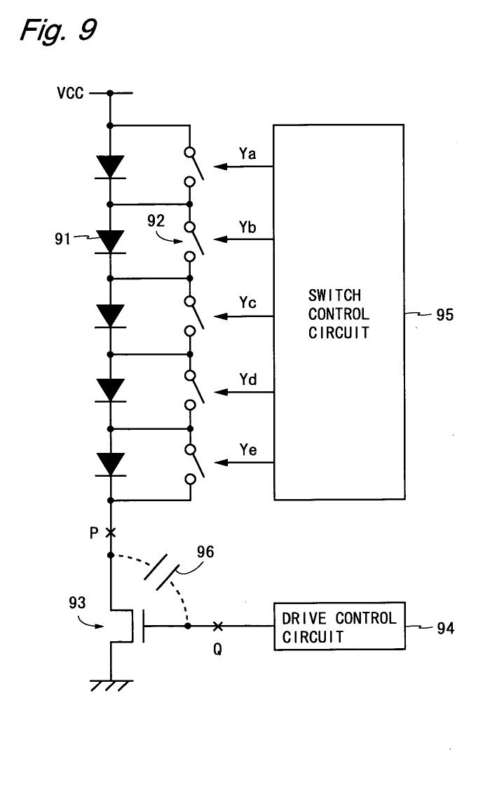

FIG. 5 is a timing chart in a case where all of the switches 92 are changed from the ON state to the OFF state at the same timing in the LED drive circuit illustrated in FIG. 9, instead of all of the switches 92 are changed from the OFF state to the ON state at the same timing (hereinafter referred to as the conventional LED drive circuit). According to the conventional LED drive circuit, switch control signals Ya to Ye change from low level to high level at the time t0. Then, the switch control signals Yb to Ye change to low level at the time t1, and the switch control signal Ya changes to low level at the time t2. Further, the switch control signals Ya to Ye change to high level at the time t3. The conventional LED drive circuit is in a state shown in FIG. 3A from the time t0 to the time t1, in a state shown in FIG. 3B from the time t1 to the time t2, and in a state shown in FIG. 3C from the time t2 to the time t3.

According to the conventional LED drive circuit, when the four switches 92 change from the OFF state to the ON state at the time t1, the drain voltage of the FET 93 (the voltage at the node P) increases from (Vcc−5×Vf) to (Vcc−Vf) (see FIG. 5). When the drain voltage of the FET 93 increases, the gate voltage of the FET 93 (the voltage at the node Q) increases due to an effect of the parasitic capacitance 96 between the drain and the gate, and the drive current that flows through the FET 93 increases accordingly. According to the conventional LED drive circuit, the switch control signal Ya remains at high level after the time t1, and the LED 91 on a first stage remains to be turned on. Accordingly, a time period until the drive current returns to an original level due to the action of the drive control circuit 94, an overcurrent Iex flows through the LED 91 on the first stage that is being turned on. As a result, there are problems that the LEDs 91 emit light at luminance higher than that has been set, and that life duration of the LEDs 91 decreases.

On the other hand, according to the LED drive circuit 10 of this embodiment, when the switches 12a to 12e change from the OFF state to the ON state at the time t3, a drain voltage of the FET 13 (the voltage at a node A) increases from (Vcc−5 ×Vf) to Vcc (see FIG. 4). Similarly to the conventional LED drive circuit, in the LED drive circuit 10, a gate voltage of the FET 13 (the voltage at a node B) increases when the of drain voltage of the FET 13 increases, and a drive current that flows through the FET 13 increases accordingly. However, in the case of the LED drive circuit 10, as all of the switches 12a to 12e are in the ON state after the time t3, the drive current does not flow through the LEDs 11a to 11e. Accordingly, the overcurrent Iex does not flow through the LEDs 11a to 11e even when the drive current is excessive. Therefore, it is possible to prevent an overcurrent from flowing through the LEDs 11 that are being turned on. Further, it is possible to reduce a current stress to the LEDs 11, and to extend the life duration of the LEDs 11.

As described above, according to the LED drive circuit 10 of this embodiment, all of the switches 12a to 12e change from the OFF state to the ON state at the same timing. Consequently, even when the drive current temporarily increases when the switches 12a to 12e change to the ON state, this current does not flow through the LEDs 11a to 11e. Therefore, it is possible to independently adjust the luminance of the LEDs 11a to 11e, and to prevent an overcurrent from flowing through the LEDs 11a to 11e.

### Second Embodiment

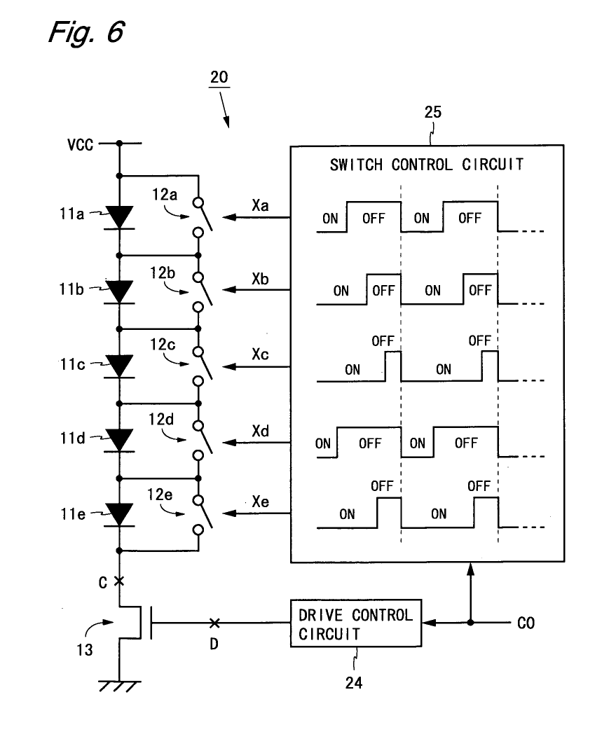

FIG. 6 is a block diagram illustrating a structure of an LED drive circuit according to a second embodiment of the present invention. An LED drive circuit 20 illustrated in FIG. 6 is such that the drive control circuit 14 and the switch control circuit 15 in the LED drive circuit 10 according to the first embodiment (FIG. 1) are replaced with a drive control circuit 24 and a switch control circuit 25. Among components of this embodiment, like components that are the same as those described in the first embodiment are denoted by like reference numerals and descriptions of such components are omitted.

The drive control circuit 24 controls the gate voltage of the FET 13, in the same manner as the drive control circuit 14, such that an amount of the drive current corresponds to a predetermined target value. The switch control circuit 25 controls on and off of the switches 12a to 12e independently, in the same manner as the switch control circuit 15, and changes all of the switches 12a to 12e from the OFF state to the ON state at the same timing.

In addition, the drive control circuit 24 has a function for switching the gate voltage of the FET 13 between high level and low level. The FET 13 is in the ON state during the gate voltage is at high level, and functions as the constant current source. In contrast, the FET 13 is in the OFF state during the gate voltage is at low level, and does not function as the constant current source.

Further, a common timing control signal C0 is inputted to the drive control circuit 24 and the switch control circuit 25. The drive control circuit 24 changes the gate voltage of the FET 13 from high level to low level based on the timing control signal C0 according to the timing at which the switch control signals Xa to Xe are switched from high level to low level. In this manner, the drive control circuit 24 stops the function as the constant current source according to the timing at which the switches 12a to 12e change to the ON state.

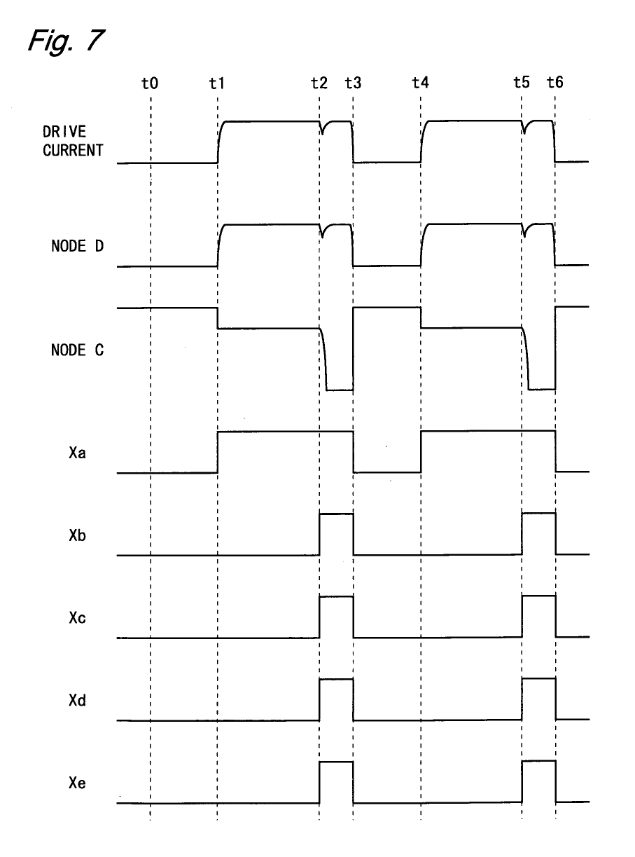

FIG. 7 is a timing chart of the LED drive circuit 20. In FIG. 7, the switch control signals Xa to Xe change in the same manner as in the chart shown in FIG. 4. The gate voltage of the FET 13 is controlled by the drive control circuit 24 so as to be at high level from the time t1 to the time t3, and to be at low level from the time t3 to the time t4. In FIG. 7, the timing at which the switch control signals Xa to Xe change to low level and the timing at which the gate voltage of the FET 13 changes to low level are substantially the same.

According to the LED drive circuit 20 of this embodiment thus configured, it is possible to effectively prevent an overcurrent from flowing through the LEDs 11a to 11e by stopping an operation of the constant current source configured by the FET 13 according to the timing at which the switches 12a to 12e change to the ON state.

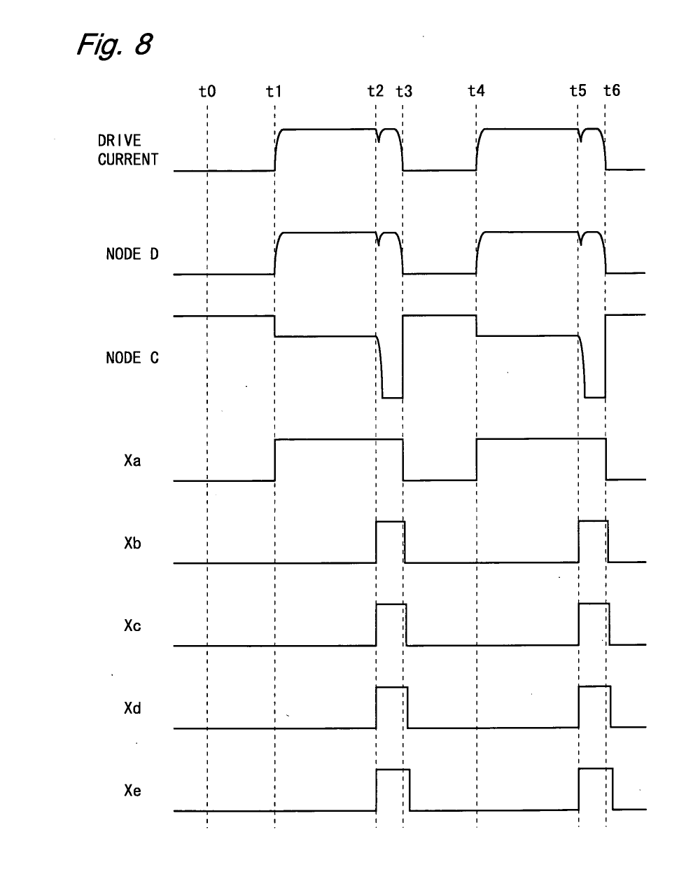

It should be understood that, as shown in FIG. 8, the drive control circuit 24 may stop the function of the constant current source configured by the FET 13 before the switches 12a to 12e change from the OFF state to the ON state by changing the gate voltage of the FET 13 from high level to low level before the switch control signals Xa to Xe change from high level to low level. With this, it is possible to prevent an overcurrent from flowing through the LEDs 11a to 11e even when there is variation in the timing at which the switches 12a to 12e change to the ON state.

It should be understood that, while the LED drive circuit has been described as an example of a light emitting device drive circuit, it is possible to configure the drive circuit for light emitting devices other than LEDs in the same manner.

### INDUSTRIAL APPLICABILITY

A light emitting device drive circuit according to the present invention is capable of adjusting luminance of light emitting devices independently and preventing an overcurrent from flowing through the light emitting devices, and therefore can be applied as a drive circuit for various light emitting devices such as LEDs.

1. A light emitting device drive circuit that drives a plurality of light emitting devices that are connected in series with constant current, the circuit comprising:
a constant current source that is connected in series to the light emitting devices;
a plurality of switches that are respectively connected in parallel with the light emitting devices; and
a switch control circuit that controls on and off of the switches independently and changes all of the switches from an OFF state to an ON state at a same timing.

2. The light emitting device drive circuit according to claim 1, further comprising:
a drive control circuit that stops an operation of the constant current source according to the timing at which the switches change to the ON state.

3. The light emitting device drive circuit according to claim 2, wherein
the drive control circuit stops the operation of the constant current source before the switches change to the ON state.

4. A display device, comprising:
a backlight drive circuit configured as the light emitting device drive circuit according to claim 1.

5. A display device, comprising:
a backlight drive circuit configured as the light emitting device drive circuit according to claim 2.

6. A display device, comprising:
a backlight drive circuit configured as the light emitting device drive circuit according to claim 3.
